(19) United States
(12) Patent Application Publication
(10) Pub. No.: US 2015/0197713 A1
(43) Pub. Date: Jul. 16, 2015

(54) Soap Sliver Element and Method for Bonding Two Surfaces

(71) Applicant: James Barrick, San Diego, CA (US)

(72) Inventor: James Barrick, San Diego, CA (US)

(21) Appl. No.: 14/157,366

(22) Filed: Jan. 16, 2014

(51) Int. Cl. C11D 13/14; B32B 37/00

(52) U.S. Cl. CPC C11D 13/14; B32B 37/0038

(57) ABSTRACT

A Soap Sliver Element and Method for Bonding Two Surfaces. The soap sliver is made from conventional materials and formed by conventional soap manufacturing processes. The soap sliver is much thinner than an ordinary bar of soap. In its best form, the bar is approximately ⅜ inches in thickness. When wetted and compressed between a pair of conventional soap bars, the soap sliver will bond the two conventional soap bars together. It is further be possible to use the soap sliver to adhere other objects to one another.

### BACKGROUND OF THE INVENTION

1. Field of the Invention

This invention relates generally to household products and adhesives and, more specifically, to a Soap Sliver Element and Method for Bonding Two Surfaces.

2. Description of Related Art

FIG. 1 depicts the conventional types of bar soap. A conventional soap bar 10A is the standard size used most widely by consumers in their home. It is usually a generally rectangular shape being three or more inches in length, two to three inches in width, and more than an inch in thickness (usually approximately 1.5 inches). A decorative soap bar 10B is typically used in guest rooms, powder rooms, and even for merely decorative or aesthetic purposes (rather than for cleansing). The bar 10B is not necessarily rectangular or square, and is usually the same general width and thickness as the conventional soap bar 10A, but it is typically shorter in length (e.g. 2.75 inches, as shown here).

Finally, the hospitality soap bar 10C is best known as the “hotel” soap bar. These are intentionally small bars, since they are not expected to be used for more than a single day. They are typically shorter and narrower than the conventional soap bars 10A, and they are much thinner than either the conventional soap bar 10A, or the decorative soap bar 10B. They can commonly be as thin as ⅜ (0.375) inches.

FIG. 2 is a flowchart depicting the conventional method for mass-producing bar soap 12. First, the base materials are mixed together (generally animal fat, water and sodium hydroxide) 100. Next, this mixture is heated 102 and then cooled 104. The cooled soap material is then pressed or chopped into nuggets or flakes 106. Fragrances and coloring is added to the nuggets/flakes 108, and these components are mixed thoroughly 110.

The colored/fragranced mix is compressed into “slugs” 112, which are generally rectangular blocks of soap. The slugs are then placed into a die cast mold 114, and pressed into their final shape. The finished soap bar ([10A], [10B] or [10C]) is ejected from the mold 116.

At its basic level, the product of the instant invention was discovered as a method for extending the life of a bar of soap. As a conventional bar of soap is used for a prolonged period of time, it will eventually erode until it is difficult to hold onto it securely. Usually, after the user drops the worn down piece of soap a few times, he or she will simply throw it in the trash, and will start on a fresh bar. Prior to the instant invention, there was no way to prolong the life of the eroded piece of soap.

### SUMMARY OF THE INVENTION

In light of the aforementioned problems associated with the prior devices and methods, it is an object of the present invention to provide a Soap Sliver Element and Method for Bonding Two Surfaces. The soap sliver should be made from conventional materials and formed by conventional soap manufacturing processes. The soap sliver should be much thinner than an ordinary bar of soap. In its best form, the bar should be approximately ⅜ inches in thickness. When wetted and compressed between a pair of conventional soap bars, the soap sliver should bond the two conventional soap bars together. It should further be possible to use the soap sliver to adhere other objects to one another.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a series of perspective views of conventional soap bars;

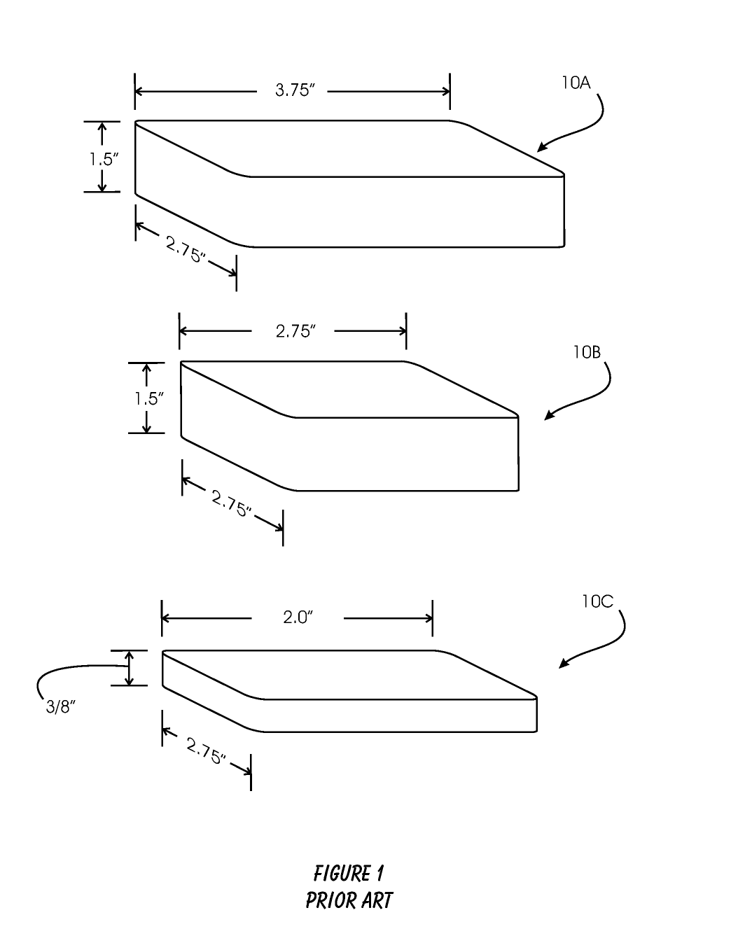

FIG. 2 is a flowchart of the conventional method for manufacturing a soap bar of FIG. 1;

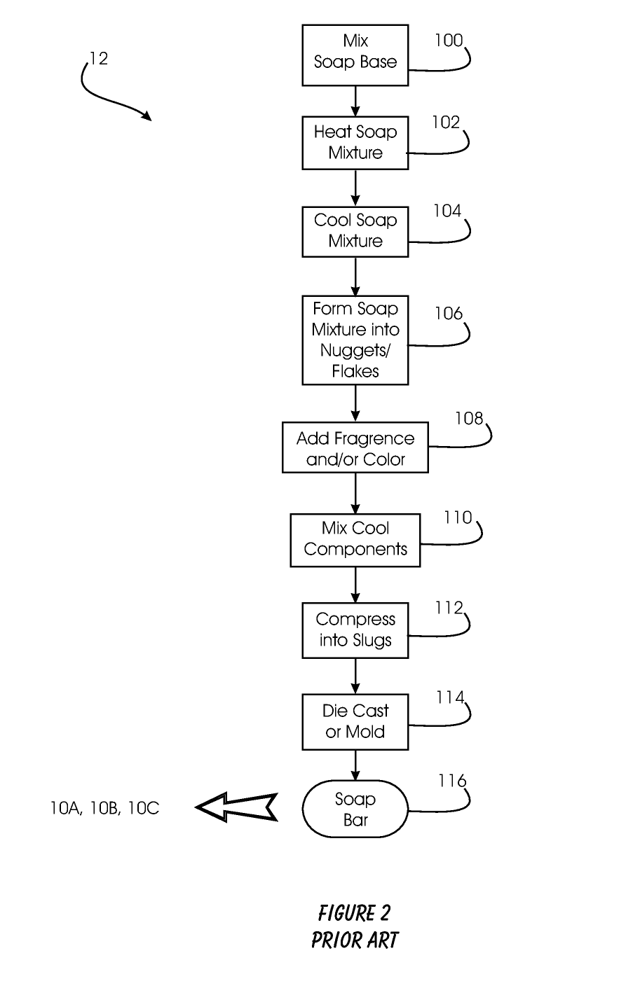

FIG. 3 is a perspective view of a preferred embodiment of a soap sliver element of the present invention;

FIG. 4 is a flowchart of a preferred method for manufacturing a soap sliver element of the present invention;

FIG. 5 is a perspective view of the arrangement for attaching two soap bars to one another using the bonding method of the present invention; and

FIG. 6 is a flowchart depicting a preferred embodiment of the bonding method of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Soap Sliver Element and Method for Bonding Two Surfaces.

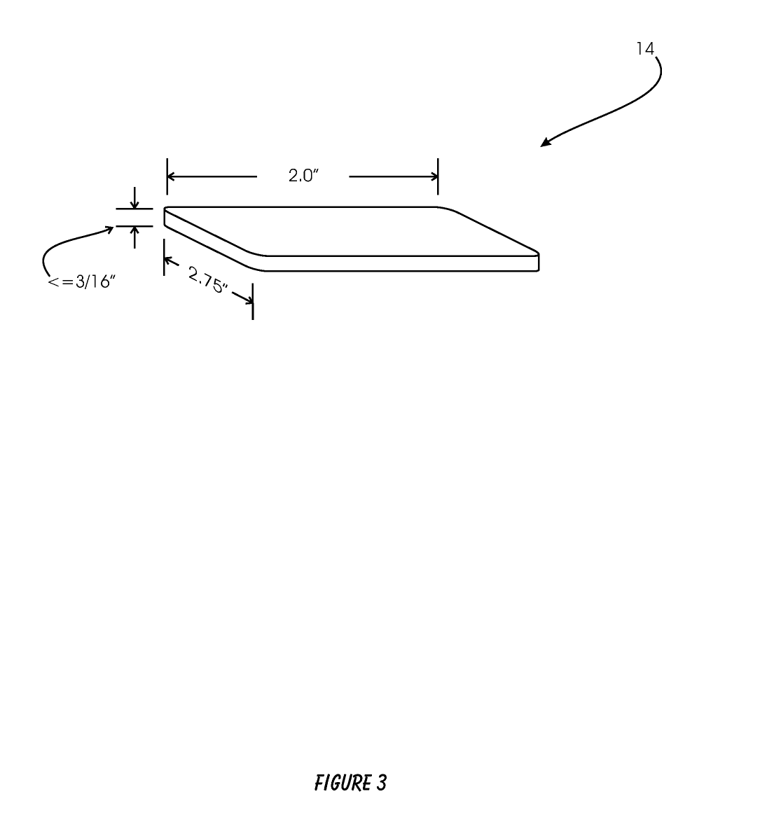

The present invention can best be understood by initial consideration of FIG. 3.¹ FIG. 3 is a perspective view of a preferred embodiment of a soap sliver element 14 of the present invention. The sliver element 14 can be generally of any width or length, particularly where it is used for more than just attaching a pair of soap bars together. In any event, what is critical to the effectiveness of the soap sliver element 14 design is that it is much thinner than a conventional bar of soap—even thinner than a hospitality soap bar [10C]. While the ideal thickness has been found to be ⅛ (0.125) inches, it could be as thick as 3/16 (0.1875) inches and still be effective. Certainly, a thickness of ⅜ (0.375) inches is much too thick. ¹ As used throughout this disclosure, element numbers enclosed in square brackets [ ] indicates that the referenced element is not shown in the instant drawing figure, but rather is displayed elsewhere in another drawing figure.

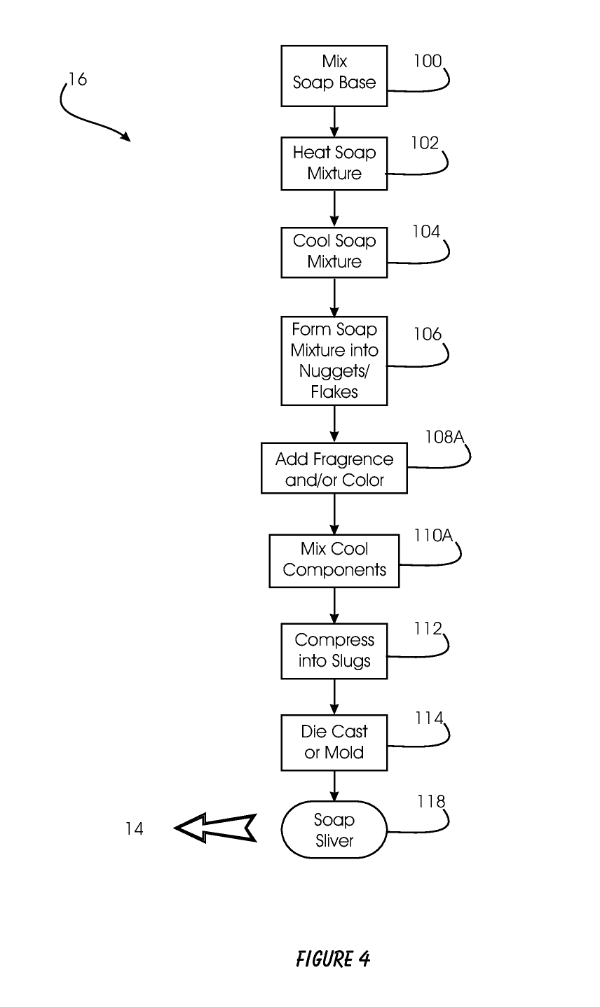

FIG. 4 is a flowchart of a preferred method for manufacturing 16 a soap sliver element of the present invention. Really, it is expected that the soap slivers 14 would be manufactured in much the same way that conventional bar soap is manufactured. However, the addition of color and fragrance 108A (and mixing them in 110A) is optional, and probably would not be employed as routinely as for convention bar soap [10A, 10B, 10C]. The final result is a soap sliver element 14 being ejected from the die cast mold 118.

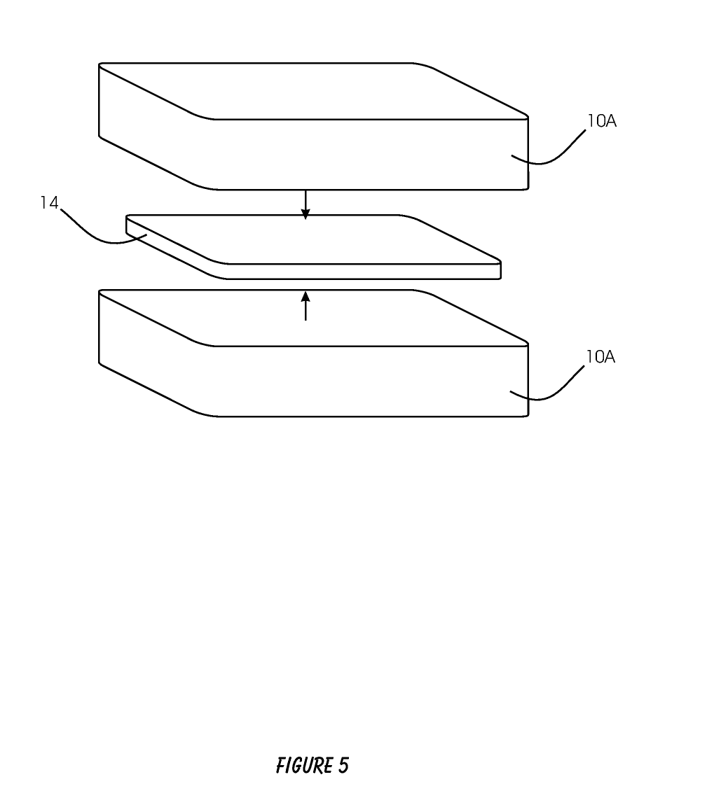

The value of the soap sliver element 14 is illustrated in FIG. 5. FIG. 5 is a perspective view of the arrangement for attaching two soap bars 10A to one another using the bonding method of the present invention. Essentially, the soap sliver element 14 acts as a bonding agent between a nearly-used bar of soap 10A, and a brand new, unused bar of soap 10A. Once bonded together by the soap sliver element 14, the two bars of soap 10A will be usable as if they were a single bar of soap, until such time as the combined bar of soap wears down to the point where another fresh bar of soap is ready to be bonded to the worn-down bar.

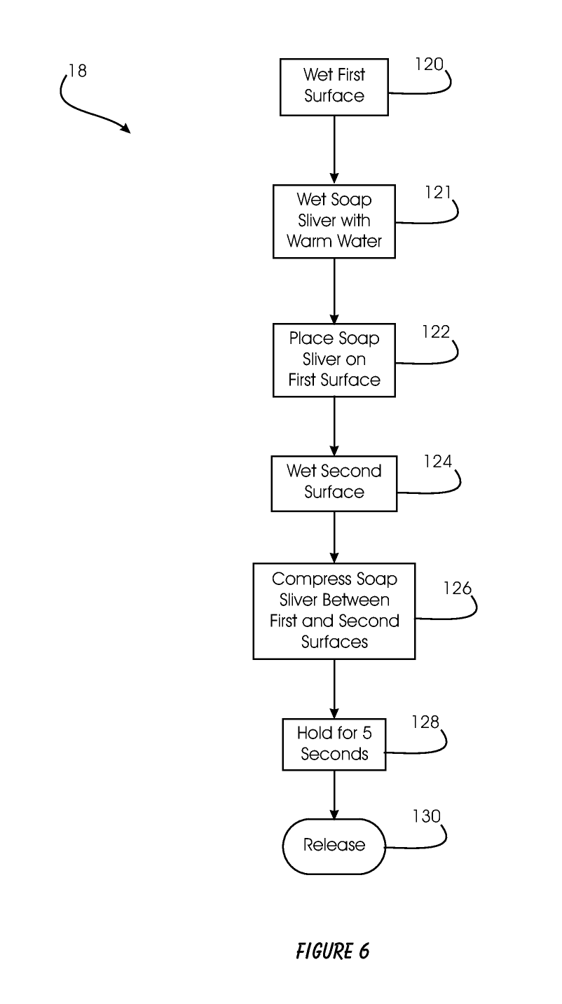

FIG. 6 is a flowchart depicting a preferred embodiment of the bonding method 18 of the present invention. One surface (e.g. of a first bar of soap [10A]) is wetted. The soap sliver element [14] is then wetted (preferably with warm water) 121. The soap sliver element [14] is then placed on the wetted surface 122, after which the second surface (e.g. a second bar of soap [10A]) is wetted. The two soap bars [10A] are compressed together 126 and held for approximately five seconds 128. Upon their release 130, the two surfaces will remain firmly bonded together by the wetted soap sliver element [14].

The terms “first” and “second” surface are used here because this bonding method has been proven effective for more than just other conventional bars of soap. Numerous separate items can be bonded together by following the method 18 described here, such as hanging a picture on the wall by bonding the picture frame to the wall.

It should also be clear that whether it is the surfaces that are wetted or whether it is the two faces of the soap sliver element [14} is not important to the bounds or functionality of the present invention. What is critical is that the faces of the soap sliver element faces that will be touching the external surfaces, are all wetted slightly.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A soap sliver element, comprising a single homogeneous piece of soap having a thickness of between 0.125 and 0.1875 inches.

2. The soap sliver element of claim 1, further defining a length of between 1.5 and 3.75 inches.

3. The soap sliver element of claim 2, further defining a width of between 1.5 and 2.75 inches.

4. The soap sliver element of claim 1, further defining a width of between 1.5 and 2.75 inches.

5. The soap sliver element of claim 4, further defining a length of between 1.5 and 3.75 inches.

6. A method for attaching a first soap bar to a second soap bar, the method comprising the steps of:
wetting a surface of said first soap bar;
placing a soap sliver element on said wetted surface of said first soap bar;
wetting a surface of said soap sliver element;
placing said second soap bar in contact with said wetted surface of said soap sliver element; and
applying compressive force onto said soap sliver element by exerting relatively opposing forces on said first and second soap bars.

7. The method of claim 6, wherein said soap sliver element of said first placing step comprises a single homogeneous piece of soap having a thickness of between 0.125 and 0.1875 inches.

8. The method of claim 7, wherein said soap sliver element of said first placing step further defines a length of between 1.5 and 3.75 inches.

9. The method of claim 8, wherein said soap sliver element of said first placing step further defines a width of between 1.5 and 2.75 inches.

10. The method of claim 7, wherein said soap sliver element of said first placing step further defines a width of between 1.5 and 2.75 inches.

11. The method of claim 10, wherein said soap sliver element of said first placing step further defines a length of between 1.5 and 3.75 inches.

12. A method for attaching a first object to a second surface, the method comprising the steps of:
wetting a surface of said first object and said second surface;
placing a soap sliver element against said wetted second surface on one side and against said wetted first object surface on an opposing side of said soap sliver element; and
applying compressive force onto said soap sliver element by exerting force on said first object in the direction of said second surface.

13. The method of claim 12, wherein said soap sliver element of said placing step comprises a single homogeneous piece of soap having a thickness of between 0.125 and 0.1875 inches.

14. The method of claim 13, wherein said soap sliver element of said placing step further defines a length of between 1.5 and 3.75 inches.

15. The method of claim 14, wherein said soap sliver element of said placing step further defines a width of between 1.5 and 2.75 inches.

16. The method of claim 13, wherein said soap sliver element of said placing step further defines a width of between 1.5 and 2.75 inches.

17. The method of claim 14, wherein said soap sliver element of said placing step further defines a length of between 1.5 and 3.75 inches.
